(19) United States
(12) Patent Application Publication
(10) Pub. No.: US 2022/0382419 A1
(43) Pub. Date: Dec. 1, 2022

(54) DISPLAY DEVICE AND CONTROL METHOD THEREOF

(71) Applicant: LG ELECTRONICS INC., Seoul (KR)

(72) Inventor: Yunoh JEONG, Seoul (KR)

(73) Assignee: LG ELECTRONICS INC., Seoul (KR)

(21) Appl. No.: 17/776,722

(22) PCT Filed: Nov. 14, 2019
(86) PCT No.: PCT/KR2019/015562

§ 371 Date: May 13, 2022

(51) Int. Cl. G06F 3/0482; G06F 16/958; G06F 3/04817

(52) U.S. Cl. CPC G06F 3/0482; G06F 16/958; G06F 3/04817

(57) ABSTRACT

A display device and a control method thereof according to an embodiment of the present invention may acquire address information of a changed default web page from a route web page of an external server for managing the default web page when the default web page to which an initial access is made to provide an image service is changed.

### TECHNICAL FIELD

The disclosure relates to a display device and a control method thereof, which operates to find a cause of an error in case that the error occurs due to a change of a video service provided from an external server, and based on this, to be provided with a normal video service.

### BACKGROUND ART

A display device is a device having a function of providing a video that a user can view. The user can view content through the display device. The display device displays the content on a screen through processing of a broadcasting signal being sent from a broadcasting station or a video signal and an audio signal input from an external device.

Further, the display device may display a video service provided by an external server. As an example, the video service may be a video service being provided from YouTube. In this case, the video service may be provided through a web page, and the video service may be provided based on software, such as an app.

Meanwhile, the display device provides the video service by initially accessing a default web page. Address information of the default web page is registered by a manager of the external server.

However, the manager of the external server may change the address information of the default web page, and in this case, the user of the display device may experience inconvenience due to the changed default web page.

### DISCLOSURE

### Technical Problem

One aspect of the disclosure is to provide a display device and a control method thereof, which operate to find a cause of an error in case that the error occurs due to a change of a video service provided from an external server, and based on this, to be provided with a normal video service.

Another aspect of the disclosure is to provide a display device and a control method thereof, which can relieve inconvenience of a user who is provided with the video service.

Aspects of the disclosure are not limited to the above-described aspects, and unmentioned other aspects and advantages of the disclosure will be understood through the following description, and will be understood more clearly by embodiments of the disclosure. Further, it will be easy to know that the aspects and advantages of the disclosure can be realized by means represented in the claims and a combination thereof.

### Technical Solution

In case that a default web page being initially accessed to provide a video service is changed, a display device and a control method thereof according to an embodiment of the disclosure can acquire address information of a changed default web page from a root web page of an external server managing the default web page.

A video display device according to an embodiment of the disclosure includes: a communication unit configured to perform communication with an external server providing a video service; a display unit configured to display the video service; and a processor configured to: access a predetermined default web page of the external server, acquire address information of a first web page from the external server in case that the accessed default web page is not the first web page including predefined first videos, and update address information of the default web page based on the acquired address information of the first web page.

A video display device according to another embodiment of the disclosure includes: a communication unit configured to perform communication with an external server providing a video service; a display unit configured to display the video service; and a processor configured to: access a root web page of the external server in case that it is not possible to access a predetermined default web page of the external server, acquire address information of a first web page corresponding to the default web page from the accessed root web page, and update address information of the default web page based on the acquired address information of the first web page.

A method for controlling a video display device according to still another embodiment of the disclosure includes: accessing a predetermined default web page of an external server; determining whether the accessed default web page is a first web page including predefined first videos; acquiring address information of the first web page from the external server in case that the accessed default web page is not the first web page; and updating address information of the default web page based on the acquired address information of the first web page.

### Advantageous Effects

According to the disclosure, the cause of the error can be found in case that the error occurs due to the change of the video service provided from the external server. Accordingly, the user can be provided with a normal video service.

Further, according to the disclosure, the inconvenience of the user who is provided with the video service can be relieved.

In addition to the above-described effects, specific effects of the disclosure will be hereinafter described together with specific matters for implementing the disclosure.

### DESCRIPTION OF DRAWINGS

FIG. 1 is a diagram illustrating the schematic configuration of a digital device according to an embodiment of the disclosure.

FIG. 2 is a diagram explaining the concept in which a display device provides a video service according to an embodiment of the disclosure.

FIG. 3 is a diagram illustrating the schematic configuration of a display device according to an embodiment of the disclosure.

FIG. 4 is a flowchart of a method for controlling a display device according to an embodiment of the disclosure.

FIG. 5 is a diagram explaining the concept of an operation of a processor 340 in step S408 performed in FIG. 4.

FIG. 6 is a diagram illustrating an example of a determination table for a live web page according to an embodiment of the disclosure.

FIG. 7 is a diagram explaining the concept of an operation of the processor 340 in steps S410, S412, S414, S416, and S418 performed in FIG. 4.

FIG. 8 is a diagram explaining the concept of an operation of the processor 340 in steps S420, S422, and S424 performed in FIG. 4.

FIG. 9 is a flowchart of a method for controlling a display device according to another embodiment of the disclosure.

### MODE FOR DISCLOSURE

The above-described aspects, features, and advantages will be hereinafter described in detail with reference to the accompanying drawings, and thus those of ordinary skill in the art to which the disclosure pertains will be able to easily embody the technical idea of the disclosure. In describing the disclosure, detailed explanation of known technology related to the disclosure will be omitted in the case where it is determined that it may unnecessarily obscure the subject matter of the disclosure. Hereinafter, preferred embodiments according to the disclosure will be described in detail with reference to the accompanying drawings. In the drawings, the same reference numerals are used to indicate the same or similar constituent elements.

The terms “first, second, and so forth” may be used to describe various constituent elements, but these constituent elements should not be limited by the terms. The above-described terms may be used only for the purpose of discriminating one constituent element from another constituent element, and unless specifically described on the contrary, the first constituent element may be the second constituent element.

Further, if it is described that a certain constituent element is “connected”, “coupled”, or “linked” to another constituent element, it should be understood that the above constituent elements may be directly connected, coupled or linked to each other, or a still another constituent element may be “interposed” between the respective constituent elements, or the respective constituent elements may be “connected”, “coupled”, or “linked” to each other through the still another constituent element.

Throughout the specification, unless specially described on the contrary, the constituent element(s) may be singular or plural.

A singular expression used in the specification includes a plural expression unless clearly differently indicated on the context. In the specification, the term “is composed of” or “includes” should not be interpreted as necessarily including all of several constituent elements or steps described in the specification, or should be interpreted as not including some of the constituent elements or steps, or should be interpreted as further including additional constituent elements or steps.

Throughout the specification, unless specially described on the contrary, the phrase “A and/or B” means A, B, or A and B, and unless specially described on the contrary, the phrase “C to D” means equal to or larger than C and equal to or smaller than D.

Meanwhile, a display device described in the specification may be, for example, an intelligent type display device having a computer support function in addition to the broadcast receiving function, and may have an interface that is more convenient to use than a handwriting type input device, a touchscreen, or a space remote controller through an added Internet function while being faithful to the broadcast receiving function. Further, the display device may perform an e-mail, web browsing, banking, or game function through being connected to the Internet and computer with a support of the wired or wireless Internet function. For such various functions, a standardized universal OS may be used.

Accordingly, the display device described in the specification may perform various user-friendly functions since various applications can be freely added or deleted on or from a universal OS kernel, for example. More specifically, for example, the display device may be a network display device, an HBB display device, or a broadcast receiving display device depending on a content receiving method, and may be an LED display device, an OLED display device, or a micro LED display device depending on a display method, and in some cases, the display device can be applied even to a mobile terminal.

Examples of the mobile terminal explained in the specification may include a portable phone, a smart phone, a laptop computer, a terminal for digital broadcasting, a personal digital assistants (PDA), a portable multimedia player (PMP), a navigation system, a slate PC, a tablet PC, an ultrabook, and a wearable device (e.g., a smartwatch, a smart glass, or a head mounted display (HMD)).

However, it can be easily understood by those skilled in the art that the configuration according to the embodiment described in the specification can be applied even to a fixed terminal, such as a digital display device, a desktop computer or a digital signage, in addition to the application to the mobile terminal.

Hereinafter, a display device and a control method thereof according to some embodiments of the disclosure will be described.

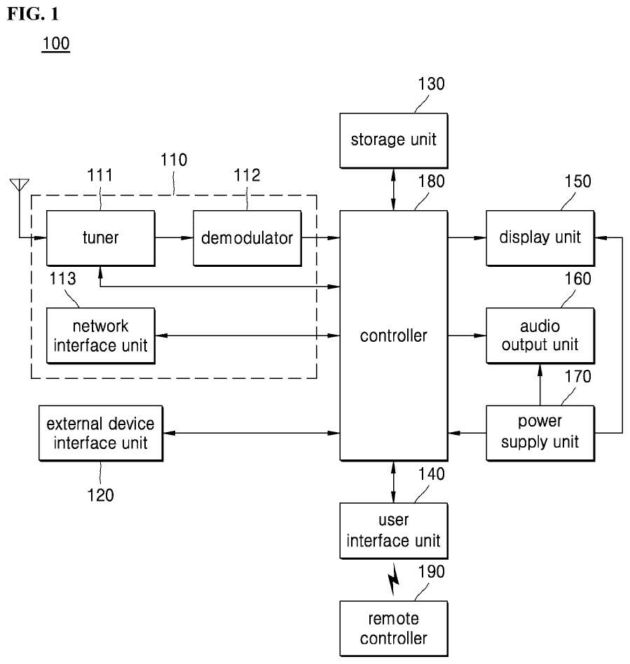

FIG. 1 is a diagram illustrating the schematic configuration of a digital device according to an embodiment of the disclosure.

Referring to FIG. 1, a digital device 100 may include a broadcast receiving unit 110, an external device interface unit 120, a storage unit 130, a user interface unit 140, a display unit 150, an audio output unit 160, a power supply unit 170, and a controller 180.

Here, the broadcast receiving unit 110 may include a tuner 111, a demodulator 112, and a network interface unit 113. However, in some cases, the broadcast receiving unit 110 may include the tuner 111 and the demodulator 112, but may not include the network interface unit 113, and vice versa.

Further, although not illustrated, the broadcast receiving unit 110 may include a multiplexer. In this case, the multiplexer may multiplex a signal demodulated by the demodulator 112 and a signal received through the network interface unit 113. In addition, although not illustrated, the broadcast receiving unit 110 may include a demultiplexer. The demultiplexer may demultiplex the multiplexed signal, or demultiplex the signal demodulated by the demodulator 112 or the signal received through the network interface unit 113.

The tuner 111 tunes a specific radio frequency (RF) broadcasting signal. The specific RF broadcasting signal corresponds to a channel selected by the user or all pre-stored channels. Further, the tuner 111 converts the RF broadcasting signal into an intermediate frequency (IF) signal or a baseband signal.

For example, the tuner 111 converts the RF broadcasting signal that is a digital broadcasting signal into a digital IF (DIF) signal, and converts the RF broadcasting signal that is an analog broadcasting signal into an analog baseband video or audio signal (CVBS/SIF). That is, the tuner 111 may process all of the digital broadcasting signal or the analog broadcasting signal. The analog baseband video or audio signal (CVBS/SIF) output from the tuner 111 may be directly input to the controller 180.

Further, the tuner 111 may receive the RF broadcasting signal of a single carrier or multiple carriers. Meanwhile, the tuner 111 may sequentially tune and receive the RF broadcasting signals of all broadcasting channels stored through a channel memory function, and may convert them into intermediate frequency signals or baseband signals.

The demodulator 112 may receive and demodulate the digital IF signal converted through the tuner 111, and may perform channel decoding or the like. For this, the demodulator 112 may be provided with a trellis decoder, a deinterleaver, and a Reed-Solomon decoder, or may be provided with a convolution decoder, a deinterleaver, and a Reed-Solomon decoder.

After performing the demodulation and channel decoding, the demodulator 112 may output a stream signal (TS). In this case, the stream signal may be a signal in which the video signal, the audio signal, or the data signal is multiplexed. As an example, the stream signal may be MPEG-2 transport stream (TS) in which the video signal of the MPEG-2 standard and the audio signal of the Dolby AC-3 standard are multiplexed.

The stream signal output from the demodulator 112 may be input to the controller 180. The controller 180 may control the demultiplexing or video/audio signal processing, and may control the output of the video through the display unit 150 and the audio through the audio output unit 160.

The external device interface unit 120 may provide an interfacing environment between the digital device 100 and various external devices.

The external device interface unit 120 may be wiredly or wirelessly connected to external devices, such as a digital versatile disk (DVD), a Blu-ray, a game device, a camera, a camcorder, a computer (notebook computer), a tablet PC, a smart phone, a Bluetooth device, and a cloud. The external device interface unit 120 transfers, to the controller 180, signals including data, such as an image, a video, and an audio, being input through the connected external device. The controller 180 may control the data signal, such as the processed image, video, and audio, to be output to a connected external device. For this, the external device interface unit 120 may further include an A/V input/output unit (not illustrated) or a wireless communication unit (not illustrated).

The A/V input/output unit may include a USB terminal, a composite video banking sync (CVBS) terminal, a component terminal, an S-video terminal (analog), a digital visual interface (DVI) terminal, a high definition multimedia interface (HDMI) terminal, an RGB terminal, and a D-SUB terminal so as to input the video and audio signals of the external device to the digital device 100.

The wireless communication unit may perform a short-range wireless communication with another digital device. For example, the digital device 100 may be network-connected to another digital device in accordance with a communication protocol, such as Bluetooth, radio frequency identification (RFID), infrared data association (IrDA), ultra wideband (UWB), ZigBee, and digital living network alliance (DLNA).

Further, the external device interface unit 120 may be connected to a set-top box (STB) through at least one of various kinds of terminals described above, and may perform an input/output operation with the set-top box (STB).

Meanwhile, the external device interface unit 120 may receive an application or an application list in the adjacent external device, and may transfer the same to the controller 180 or the storage unit 130.

The network interface unit 113 provides an interface for connecting the digital device 100 to a wired/wireless network. The network interface unit 113 may be provided with an Ethernet terminal for connection with the wired network, and may use the communication standards, such as wireless LAN (WLAN), Wi-Fi, wireless broadband (Wibro), world interoperability for microwave access (Winmax), and high speed downlink packet access (HSDPA) for connection with the wireless network.

The network interface unit 113 may transmit and receive data to and from another digital device through the connected network or another network linked to the connected network. In particular, the network interface unit 113 may transmit some content data stored in the digital device 100 to the digital device selected from other pre-registered digital devices.

Meanwhile, the network interface unit 113 may access a specific web page through the connected network or another network linked to the connected network. That is, the network interface unit 113 may access the specific web page through the network, and may transmit or receive data to or from the corresponding server. In addition, the network interface unit 113 may receive content or data being provided by a content provider or a network operator. That is, the network interface unit 113 may receive content, such as movie, advertisement, game, VOD, and broadcasting signal, being provided from the content provider or the network operator, and information related to the content through the network. Further, the network interface unit 113 may receive firmware update information and update files being provided by the network operator. Further, the network interface unit 113 may transmit data to the Internet, the content provider, or the network operator.

The network interface unit 113 may select and receive a desired application among applications open through the network.

The storage unit 130 may store programs for processing and controlling respective signals in the controller 180, and may store the signal-processed video, audio, or data signal.

The storage unit 130 may temporarily store the video, audio, or data signal input from the external device interface unit 120 or the network interface 113. The storage unit 130 may store information on a specified broadcasting channel through the channel memory function.

The storage unit 130 may store the application or the application list input from the external device interface unit 120 or the network interface unit 113.

The storage unit 130 may also store various platforms to be described later.

For example, the storage unit 130 may include at least one type storage medium among a flash memory type memory, a hard disk type memory, a multimedia card micro type memory, and a card type memory (e.g., SD or XD memory), a RAM, and a ROM (EEPROM). The digital device 100 may reproduce and provide a user with a content file (video file, still image file, music file, text file, and application file) stored in the storage unit 130.

Meanwhile, the storage unit 130 may be included in the controller 180, or may be provided separately from the controller 180.

The user input interface unit 140 transfers the signal input by the user to the controller 180, or transfers the signal of the controller 180 to the user.

For example, the user input interface unit 140 may be connected to a remote controller 190 in accordance with various communication methods, such as RF communication method and infrared (IR) communication method, receive and process control signals, such as power on/off, channel selection, and screen setting, being transmitted from the remote controller 190, or transmit the control signal of the controller 180 to the remote controller 190. Further, the user input interface unit 140 may transfer control signals input from a local key (not illustrated) such as a power key, a channel key, a volume key, and a setup key to the controller 180.

The user input interface unit 140 may transfer the control signal input from a sensing unit (not illustrated) that senses user's gestures to the controller 180, or may transmit the signal of the controller 180 to the sensing unit (not illustrated). Here, the sensing unit (not illustrated) may include a touch sensor, a voice sensor, a position sensor, and a motion sensor.

The controller 180 may demultiplex the stream input through the tuner 111, the demodulator 112, or the external device interface unit 120, may process demultiplexed signals, and may generate and output a signal for video or audio output.

The video signal processed by the controller 180 may be input to the display unit 150, and may be displayed as a video corresponding to the corresponding video signal. Further, the video signal processed by the controller 180 may be input to an external output device through the external device interface unit 120.

The audio signal processed by the controller 180 may be output to the audio output unit 160. Further, the audio signal processed by the controller 180 may be input to the external output unit through the external device interface unit 120.

Meanwhile, the controller 180 may include a demultiplexer and a video processing unit.

The controller 180 may control the overall operation of the digital device 100. For example, the controller 180 may control the tuner 111 to tune the RF broadcast corresponding to the channel selected by the user or the pre-stored channel.

The controller 180 may control the digital device 100 by a user command input through the user input interface unit 140 or an internal program. In particular, the user may download an application or an application list desired by the user into the digital device 100 by accessing the network.

For example, the controller 180 may control the tuner 111 to input the signal of the channel selected in accordance with a specific channel selection command received through the user input interface unit 140. Further, the controller 180 processes the video, audio, or data signal of the selected channel. The controller 180 controls the channel information selected by the user to be output through the display unit 150 or the audio output unit 160 together with the processed video or audio signal.

As another example, the controller 180 controls the video signal or the audio signal from the external device to be output through the display unit 150 or the audio output unit 160 in accordance with an external device video playback command received through the user input interface unit 140.

Meanwhile, the controller 180 may control the display unit 150 to display the video. For example, the controller 180 may control the display unit 150 to display a broadcasting video input through the tuner 111, an external input video input through the external device interface unit 120, a video input through the network interface unit, or a video stored in the storage unit 130. In this case, the video displayed on the display unit 150 may be a still image or a video, and may be a 2D video or a 3D video.

Further, the controller 180 may control the display unit 150 to reproduce content. In this case, the content may be the content stored in the digital device 100, the received broadcasting content, or the external input content input from an outside. The content may be at least one of a broadcasting video, an external input video, an audio file, a still image, an accessed web screen, and a text file.

Meanwhile, in case of entering an application view item, the controller 180 may control the display unit 150 to display an application or an application list that can be downloaded from a network inside or outside the digital device 100.

Together with various user interfaces, the controller 180 may control the application being downloaded from the external network to be installed and driven. Further, the controller 180 may control the video related to the application being executed through the selection of the user to be displayed on the display unit 150.

Meanwhile, although not illustrated in the drawing, a channel browsing processor that generates a thumbnail image corresponding to the channel signal or the external input signal may be further provided.

The channel browsing processor may receive an input of the stream signal (TS) output from the demodulator 112 or the stream signal output from the external device interface unit 120, and may generate the thumbnail video through extraction of the video from the input stream signal. The generated thumbnail video may be input to the controller 180 as it is or after being encoded. Further, the generated thumbnail video may be encoded in the form of a stream and is input to the controller 180. The controller 180 may display a thumbnail list provided with a plurality of thumbnail videos on the display unit 150 by using the input thumbnail video. Meanwhile, the thumbnail videos in the thumbnail list may be updated in turn or at the same time. Accordingly, the user can easily grasp the contents of the plurality of broadcasting channels.

The display unit 150 generates a driving signal by converting the video signal, the data signal, or an OSD signal processed by the controller 180, or the video signal and the data signal received by the external device interface unit 120 into RGB signals.

The display unit 150 may be a PDP display, an LCD display, an OLED display, a flexible display, or a 3D display.

Meanwhile, the display unit 150 may be configured as a touch screen and used as an input device in addition to an output device.

The audio output unit 160 receives an input of a signal voice-processed by the controller 180, for example, a stereo signal, 3.1 channel signal, or 5.1 channel signal, and outputs the signal as voice. The audio output unit 160 may be implemented as various types of speakers.

Meanwhile, in order to sense the user's gesture, as described above, the digital device may further include the sensing unit (not illustrated) provided with at least one of a touch sensor, a voice sensor, a position sensor, and a motion sensor. The signal sensed by the sensing unit (not illustrated) may be transferred to the controller 180 through the user input interface unit 140.

Meanwhile, a photographing unit (not illustrated) for photographing the user may be further provided. The video information photographed by the photographing unit (not illustrated) may be input to the controller 180.

The controller 180 may sense the user's gesture by means of the video photographed by the photographing unit (not illustrated) and the signal sensed by the sensing unit (not illustrated) individually or in combination.

The power supply unit 170 supplies power to the constituent elements of the digital device 100. In particular, the power supply unit 170 may supply the power to the controller 180 that can be implemented in the form of a system on chip (SoC), the display unit 150 for the video display, and the audio output unit 160 for the audio output.

For this, the power supply unit 170 may be provided with a converter (not illustrated) that converts an AC power into a DC power. Meanwhile, in case that the display unit 150 is implemented as a liquid crystal panel provided with a plurality of backlight lamps, the power supply unit 170 may be further provided with an inverter (not illustrated) capable of performing a pulse width modulation (PWM) operation for luminance variation or dimming driving.

The digital device 100 may be a digital broadcasting receiver capable of processing a fixed or mobile ATSC type or DVB type digital broadcasting signal.

In addition, as needed, the digital device 100 may omit some of configurations illustrated, or may further include configurations not illustrated on the contrary. Meanwhile, unlike the configuration described above, the digital device 100 may not be provided with the tuner and the demodulator, and may receive and reproduce the content through the network interface unit or the external device interface unit.

Meanwhile, among the digital devices 100, the display device, such as a smart TV, may be an intelligent device having a computer support function in addition to the broadcast receiving function. In particular, the display device executes a video service being provided from the external server. As an example, the external server may be a server being managed by a company that provides the video service, such as YouTube.

The video service may be provided through an app (or software). Further, a default web page for providing the video service is registered in the display device, and a user is provided with the video service through selection of a specific app. In this case, the default web page is one of web pages being managed by the external server. As an example, the default web page may be a web page in which real-time streaming videos are gathered.

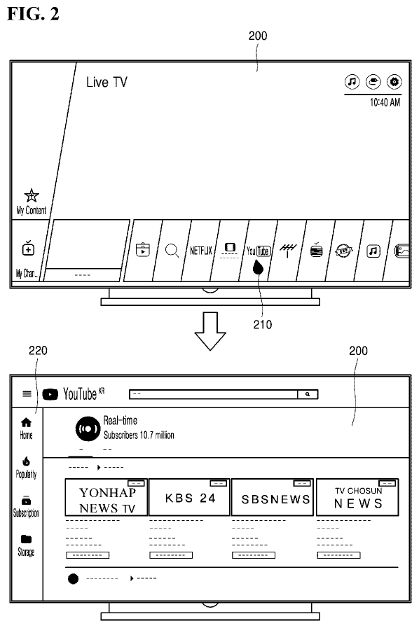

Referring to FIG. 2, in case that a user executes a specific app through a cursor 210, a display device 200 accesses a default web page 220, and schematic information on videos present in the default web page is displayed.

However, a video service provider may change the default web page without notifying a company that produces the display device, and the display device may display a screen of the changed default web page when the app is executed. Further, the video service provider may delete the default web page without notifying the company that produces the display device. In this case, users who are familiar with the default web page before being changed may experience inconvenience when they receive the video service, and may make a claim against the company that produces the display device.

Hereinafter, with reference to the above-described contents, a display device and a control method thereof according to an embodiment of the disclosure will be described.

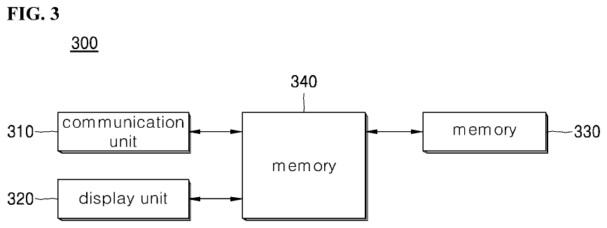

FIG. 3 is a diagram illustrating the schematic configuration of a display device according to an embodiment of the disclosure.

Referring to FIG. 3, a display device 300 may be the display device as illustrated in FIG. 2, and includes a communication unit 310, a display unit 320, a memory 330, and a processor 340.

Hereinafter, functions of respective constituent elements will be described in detail.

The communication unit 310 performs communication with at least one external server that provides a video service.

As an example, communication technology being used by the communication unit 310 includes global system for mobile communication (GSM), code division multi access (CDMA), long term evolution (LTE), 5G, wireless LAN (WLAN), and wireless-fidelity (Wi-Fi).

Meanwhile, for convenience in explanation, an embodiment of the disclosure will be described around the contents in which one external server and the display device 200 interlock with each other.

The display unit 320 may be a device that is composed of a liquid crystal display (LCD), a light-emitting diode display (LED), or an organic light-emitting diode display (OLED), and displays a video service to a user.

The memory 330 may be a volatile and/or nonvolatile memory, and stores a command or data related to at least one other constituent element of the display device 300. In particular, the memory 330 may store address information of a default web page that is an initial web page for providing the video service.

The processor 340 may include one or more of a central processing unit, an application processor, or a communication processor. The processor 340 may execute an operation or data processing related to the control and/or communication of at least one other constituent element of the display device 300.

In particular, as described above, a video service provider may change a default web page without notification, and the processor 340 performs recovering of the default web page.

Hereinafter, with reference to the drawings below, an operation of the processor 340 recovering the default web page, that is, a method for controlling the display device 300, will be described in more detail.

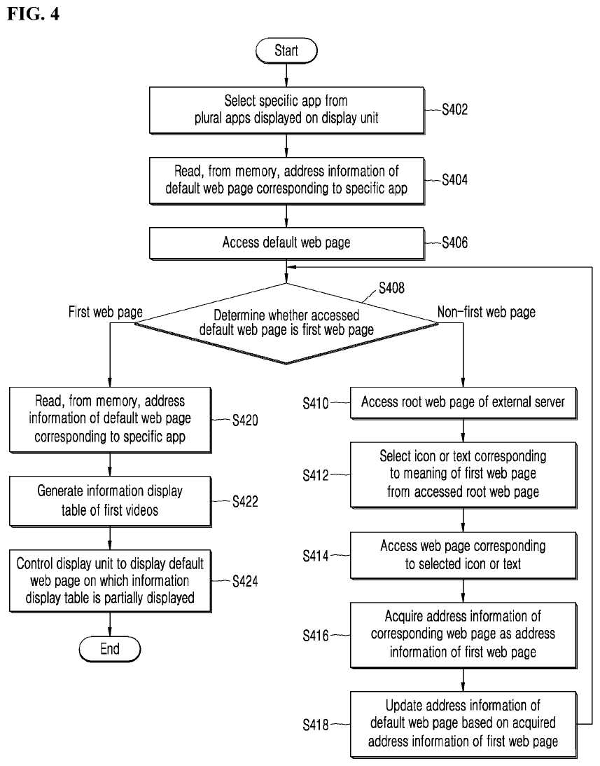

FIG. 4 is a diagram illustrating a flowchart of a method for controlling a display device 300 according to an embodiment of the disclosure.

Meanwhile, it is assumed that the display device 300 is in a turned-on state, and a plurality of apps for providing specific services are displayed on the display unit 320.

Hereinafter, a process being performed by steps will be described in detail.

In step S402, in accordance with a user's event, the processor 340 selects a specific app among the plurality of apps displayed on the display unit 320.

As an example, the user performs an event for operating a remote controller, and the processor 340 selects the specific app among the apps displayed on the display unit 320 based on the signal received from the remote controller or the like.

In step S404, the processor 340 reads address information of a default web page corresponding to the selected specific app from the memory 330.

As an example, the memory 330 may include an embedded multimedia card (eMMC), and the eMMC may store address information of the default web pages of the plurality of apps.

The address information of the default web page may be one web page being displayed in case that the app is initially executed among web pages managed by the external server corresponding to the app.

As an example, the default web page may be a live web page in which live videos that the external server streams in real time are gathered.

In step S406, the processor 340 accesses the default web page corresponding to the specific app.

In this case, the step S406 may be performed through a background task, and the accessed default web page may not be displayed on the display unit 320.

In step S408, the processor 340 determines whether the accessed default web page is a first web page including first videos.

In this case, the first video may be predefined. As an example, the first video may be a live video. In this case, the first web page may be a live web page including a live video.

According to an embodiment of the disclosure, the processor 340 may extract icons and texts displayed on the default web page, and may determine whether the accessed default web page is the first web page through analysis of the extracted icons and texts.

In this case, the processor 340 may extract the text using a text recognition algorithm, and may extract the icon by using an image scan algorithm. Further, the icon means a small pictogram on the web page defined in a computer display.

More specifically, the processor 340 selects one or more icons and texts corresponding to the definition of the first video among the extracted icons and texts, and determines that the default web page is the first web page in case that the number of the selected icons and texts is equal to or larger than a predetermined threshold value or threshold rate.

As an example, if the first video is a live video, the processor 340 may select the icon and the text corresponding to the meaning of “real time” or “live (or live broadcasting)”, and may determine that the default web page is the live web page (i.e., first web page) in case that the number of the selected icons and texts is equal to or larger than the threshold value.

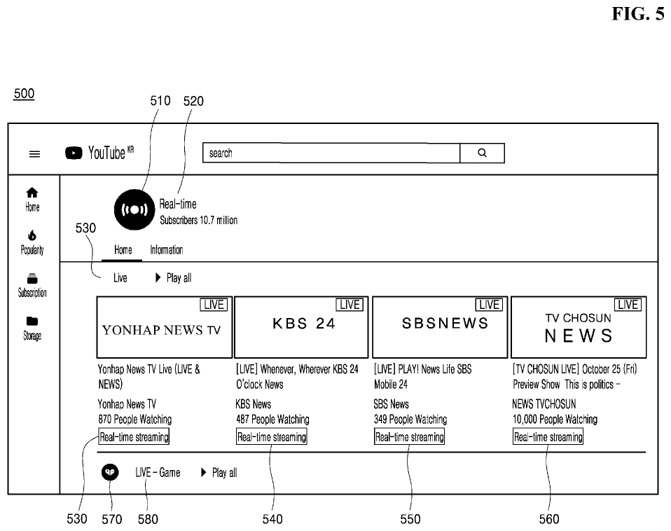

FIG. 5 is a diagram explaining the concept of an operation of a processor 340 performed in step S408.

Referring to FIG. 5, the processor 340 extracts icons and texts from a default web page 500. Thereafter, the processor 340 selects one icon 510 and five texts 520, 530, 540, 550, and 560 corresponding to the meaning of “real time” among the extracted icons and texts. Further, the processor 340 selects one icon 570 and one text 580 corresponding to the meaning of “live” among the extracted icons and texts.

In this case, if it is assumed that six threshold values are provided, the number of the selected icons and texts is 8, and thus the processor 340 determines that the default web page is the live web page.

Meanwhile, a non-live video may be included in the live web page. In this case, if the number of the selected icons and texts is equal to or larger than the threshold rate, the processor 340 may determine that the default web page is the live web page.

According to an embodiment of the disclosure, the processor 340 may extract the icons and texts displayed on the default web page, and may determine whether the accessed default web page is the first web page through analysis of the extracted icons and texts.

Meanwhile, in order to select one or more icons and texts corresponding to the definition of the first video among the extracted icons and texts, a determination table may be used. The determination table may be stored in the memory 330.

In the determination table, a plurality of determination criteria information may be included. Each of the plurality of determination criteria information may include a standard text, and may selectively include a standard icon corresponding to the standard text. The standard texts and the standard icons may be configured in pairs, and the standard text and the standard icon may be positioned adjacent to each other on the web page.

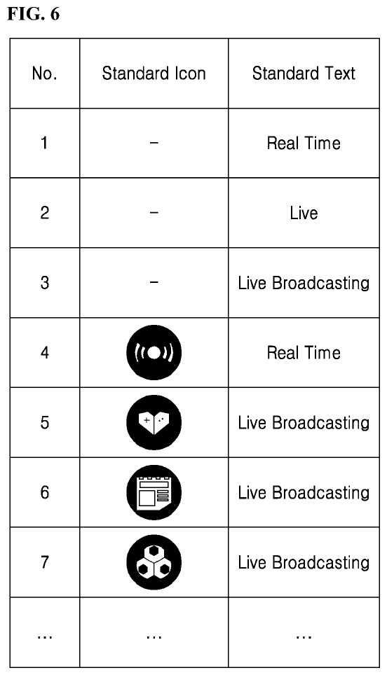

FIG. 6 illustrates an example of a determination table for a live web page.

Referring to FIG. 6, the determination table includes a plurality of determination criteria information. Among them, three determination criteria information include only a standard text, and the remaining determination criteria information include the standard text and the standard icon matching the standard text.

In this case, the fourth standard icon is an icon corresponding to a live web page, the fifth standard icon is an icon corresponding to a live video for a game, the sixth standard icon is an icon corresponding to a live video for news, and the seventh standard icon is an icon corresponding to a live video for sports.

Meanwhile, the processor 340 may add a new standard icon to the determination table.

That is, a new icon A may be included on the web page, and text A may be located adjacent to icon A. In this case, the processor 340 extracts icon A and text A being adjacently displayed on the web page. In this case, if text A has the meaning of “real time” or “live”, the processor 340 may add icon A and text A to the determination table as one determination criteria information. Accordingly, the determination table is updated without intervention of a manager.

In short, the processor 340 may select one or more icons and texts through comparison of a plurality of determination criteria information included in the determination table and extracted icons and texts with one another. Accordingly, whether the default web page is the first web page can be identified more quickly.

Referring again to FIG. 4, the method for controlling the display device 300 according to the first embodiment of the disclosure will be described.

Steps S410 to S418 are steps being performed in case that the default web page is not the first web page, and steps S420 to S424 are steps being performed in case that the default web page is the first web page. Each of the steps will be described in more detail as follows.

First, steps S410 to S418 correspond to a process of acquiring the address information of the first web page from the external server, and updating the address information of the default web page based on the acquired address information of the first web page in case that the default web page is not the first web page. In this case, steps S410 to S418 may also be performed through a background task.

In step S410, the processor 340 accesses a root web page of the external server.

Here, the root web page may be a default web page or a home page of a video service provider.

In step S412, the processor 340 selects the icon or text corresponding to the meaning of the first web page from the accessed root web page.

As an example, in case that the first web page is the live web page including a live video, the processor 340 selects the icon or text corresponding to the meaning of “real time” or “live”.

In step S414, the processor 340 accesses the web page corresponding to the selected icon or text.

In step S416, the processor 340 acquires the address information of the corresponding web page as the address information of the first web page.

In step S418, the processor 340 may update the address information of the default web page based on the acquired address information of the first web page.

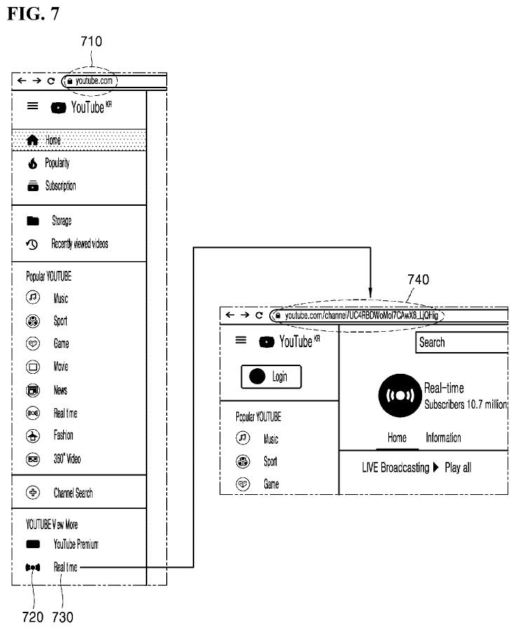

FIG. 7 is a diagram explaining the concept of a process in which steps S410 to S418 are performed. For convenience in explanation, it is assumed that the first video is a live video, and the first web page is a live web page.

Referring to FIG. 7, the processor 350 accesses a root web page 710 of the external server, and selects an icon 720 or a text 730 corresponding to the meaning of “real time” or “live” by using a text recognition algorithm and an image scan algorithm. Further, the processor 350 accesses the live web page through selection of the selected icon or text, and acquires address information 740 of the live web page. Thereafter, the processor 340 updates the address information of the default web page based on the address information of the live web page.

In short, through steps S410 to S418 according to the disclosure, even if the video service provider changes the default web page without notifying the company that produces the display device, the display device 300 may automatically recover the address information of the default web page having been initially configured without intervention of the manager. Accordingly, the inconvenience being experienced when users who are familiar with the default web page before being changed are provided with the video service can be relieved.

Next, steps S420 to S426 correspond to a process of generating index information of the first videos included in the default web page through analysis of the default web page, and controlling to display the generated index information on the display unit in case that the default web page is the first web page. In this case, steps S418 to S424 may also be performed through the background task.

In step S420, the processor 340 parses the default web page. Accordingly, index information of the first videos included in the default web page is generated.

Here, the index information includes information on the service provider streaming the first video and title information of the first video.

In step S422, the processor 340 generates an information display table of the first video being provided in real time by using the generated index information of the first videos.

In step S424, the processor 340 controls to display, on the display unit 320, the default web page on which the information display table is partly displayed.

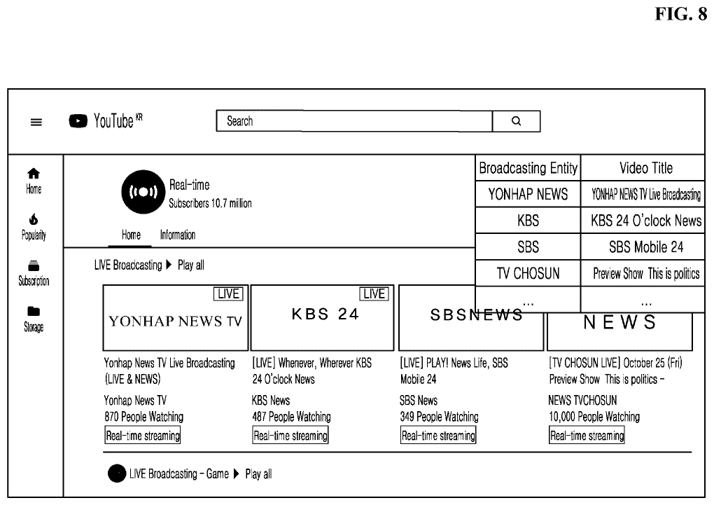

FIG. 8 is a diagram explaining the concept of a process in which steps S420 to S424 are performed. For convenience in explanation, it is assumed that a first video is a live video, and a first web page is a live web page.

Referring to FIG. 8, a default web page including a first video streaming in real time and an information display table are displayed on a display unit 320 together.

In summary, in case that the default web page being initially accessed to provide a video service is changed, the display device 300 according to the disclosure recover this, and thus an error of the video service being provided from the external server can be prevented from occurring, and the inconvenience of the user who is provided with the video service can be relieved.

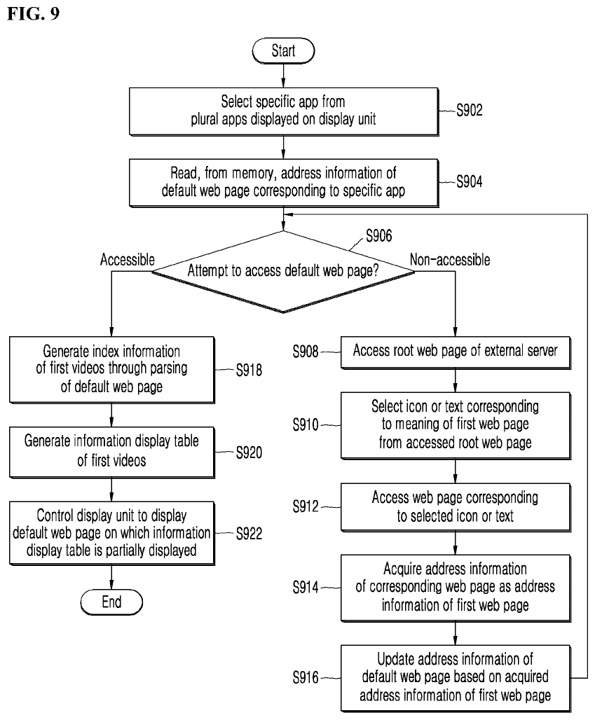

FIG. 9 is a diagram illustrating a flowchart of a method for controlling a display device 300 according to another embodiment of the disclosure.

Meanwhile, it is assumed that the display device 300 is in a turned-on state, and a plurality of apps for providing specific services are displayed on the display unit 320.

Hereinafter, a process being performed by steps will be described in detail.

In step S902, in accordance with a user's event, the processor 340 selects a specific app among the plurality of apps displayed on the display unit 320.

In step S904, the processor 340 reads address information of a default web page corresponding to the selected specific app from the memory 330.

In step S906, the processor 340 attempts an access to the default web page corresponding to the specific app.

If the access to the default web page is not possible, the processor 340 accesses a root web page of the external server (S908), selects an icon or a text corresponding to the meaning of a first web page from the accessed root web page (S910), accesses a web page corresponding to the selected icon or text (S912), acquires address information of the corresponding web page as address information of the first web page (S914), and updates address information of the default web page based on the acquired address information of the first web page (S916).

That is, a case where the default web page is deleted may occur, and in this case, a blank web page may be displayed on the display unit 320. Accordingly, the processor may recover the default web page through steps S908 to S916.

In contrast, if the access to the default web page is possible, the processor 340 generates index information of the first videos by parsing the default web page (S918), generates information display table of the first video being provided in real time by using the generated index information of the first videos (S920), and controls to display, on the display unit 320 the default web page on which the information display table is partly displayed.

Further, although it has been explained that all constituent elements constituting an embodiment of the disclosure are combined into one or operate in combination, the disclosure is not necessarily limited to such an embodiment, but one or more of all constituent elements may operate in selective combination within the purpose scope of the disclosure. Further, although all constituent elements may be independently implemented by hardware, some or all of the respective constituent elements may be selectively combined, and may be implemented as a computer program having program modules performing some or all of functions combined in one or a plurality of hardware configurations. Codes and code segments constituting the computer program may be easily inferred by those skilled in the art to which the disclosure pertains. The computer program may be stored in computer readable media, and may be read and executed by the computer to implement the embodiment of the disclosure. The computer program storage media include storage media including a magnetic recording medium, an optical recording medium, and a semiconductor recording element. Further, the computer program implementing the embodiment of the disclosure includes program modules being transmitted in real time through an external device.

From the foregoing, although the disclosure has been described with reference to the exemplified drawings, it is obvious that the disclosure is not limited by the embodiments and the drawings disclosed in the specification, but various modifications will be made by those of ordinary skill in the art to which the disclosure pertains within the scope of the technical idea of the disclosure. Further, even if the operational effects according to the configuration of the disclosure have not been explicitly described or explained while explaining the embodiment of the disclosure, it is apparent that effects that can be predicted by the corresponding configuration should also be accepted.

1. A video display device comprising:
a communication unit configured to perform communication with an external server providing a video service;
a display unit configured to display the video service; and
a processor configured to: access a predetermined default web page of the external server, acquire address information of a first web page from the external server in case that the accessed default web page is not the first web page including predefined first videos, and update address information of the default web page based on the acquired address information of the first web page.

2. The video display device of claim 1, further comprising a memory configured to store the address information of the default web page.

3. The video display device of claim 1, wherein the processor is configured to: extract icons and texts displayed on the default web page, and determine whether the accessed default web page is the first web page through analysis of the extracted icons and texts.

4. The video display device of claim 3, wherein the processor is configured to: select one or more icons and texts corresponding to the first video among the extracted icons and texts, and determine that the default web page is the first web page in case that the number of the selected icons and texts is equal to or larger than a predetermined threshold value or threshold rate.

5. The video display device of claim 4, wherein the first video is a live video that the external server streams in real time, and the one or more icons and texts corresponding to the first video have a meaning of “real time” or “live”.

6. The video display device of claim 4, wherein the processor is configured to: extract the texts by using a text recognition algorithm, and extract the icon by using an image scan algorithm.

7. The video display device of claim 4, wherein the memory is configured to further store a determination table,
the processor is configured to select the one or more icons and texts based on the determination table, and
the determination table includes a plurality of determination criteria information, each of the plurality of determination criteria information includes a standard text and selectively includes a standard icon corresponding to the standard text, and the standard icon and the standard text are adjacently displayed on the web page.

8. The video display device of claim 7, wherein the first video is a live video that the external server streams in real time, and
the processor is configured to: extract icon A and text A adjacently displayed on the web page, and update the determination table through addition of the icon A and the text A as the determination criteria information in case that the text A has the meaning of “real time” or “live”.

9. The video display device of claim 1, wherein the processor is configured to: access a root web page of the external server, select the icon or text corresponding to a meaning of the first web page from the accessed root web page, access a web page corresponding to the selected icon or text, and acquire address information of the corresponding web page as the address information of the first web page.

10. The video display device of claim 1, wherein in case that the accessed default web page is the first web page, the processor is configured to: generate index information of the first videos included in the default web page through analysis of the default web page, and control the display unit to display the generated index information.

11. A video display device comprising:
a communication unit configured to perform communication with an external server providing a video service;
a display unit configured to display the video service; and
a processor configured to: access a root web page of the external server in case that it is not possible to access a predetermined default web page of the external server, acquire address information of a first web page corresponding to the default web page from the accessed root web page, and update address information of the default web page based on the acquired address information of the first web page.

12. The video display device of claim 11, wherein the default web page or the first web page is a live web page of the external server.

13. The video display device of claim 12, wherein the processor is configured to: select an icon or text corresponding to a meaning of “real time” or “live” from the root web page, access a web page corresponding to the selected icon or text, and acquire address information of the corresponding web page as the address information of the first web page.

14. A method for controlling a video display device including a processor, the method comprising:
accessing a predetermined default web page of an external server;
determining whether the accessed default web page is a first web page including predefined first videos;
acquiring address information of the first web page from the external server in case that the accessed default web page is not the first web page; and
updating address information of the default web page based on the acquired address information of the first web page.

15. The method of claim 15, wherein the first video is a live video that the external server streams in real time, and
the default web page or the first web page is a live web page of the external server.
